(19) United States
(12) Patent Application Publication
(10) Pub. No.: US 2006/0280584 A1
(43) Pub. Date: Dec. 14, 2006

(54) Lift attachment for an ATV

(76) Inventors: Corey Spuzak, Fort Frances (CA); Micheal Spuzak, Fort Frances (CA)

Correspondence Address: Mr. Adrian D. Battison;Ade & Company Inc., P.O. Box 28006, 1795 Henderson Highway, Winnipeg, MB, R2G 1P0, CA

(21) Appl. No.: 11/474,265

(22) Filed: Jun. 26, 2006

(30) Foreign Application Priority Data
May 27, 2005 (CA) 2,510,342

(51) Int. Cl. B60P 9/00

(52) U.S. Cl. 414/462

(57) ABSTRACT

An ATV has a lift attachment for including a front bracket for mounting on the frame of the ATV at the front between the front wheels and having a pulley thereon for guiding the cable from the winch underneath the ATV to travel between the wheels to the rear wherein there is mounted a support arm carried on a bottom mounting bar connected to the hitch coupling of the ATV. The support arm has an outer fixed tube and an inner slidable tube with an inclined support portion carrying a coupling plate at the outer end with a hole therein for receiving a hook of a support pulley block. A pulley is located on a side of the support arm opposite the hitch at the bottom of the support arm such that a cable from the winch on the ATV can pass underneath the ATV to the pulley, around the pulley to the pulley block on the end of the support portion and to a load to be lifted and towed by the ATV.

This invention relates to a lift attachment which can be mounted on an ATV for cooperation with an existing winch of the ATV to lift materials for towing.

### BACKGROUND OF THE INVENTION

ATV vehicles, while often used for recreation purposes, are also useful for performing work related duties such as clearing a small area of land that is difficult to reach or navigate with a larger vehicle or machine. Due to the size or weight of cargo involved in such activities, accessories for transporting a large load are sometimes necessary. U.S. Pat. No. 6,231,030 describes a log skidder designed for towing behind an ATV which features a vertical hoist and electric winch for lifting an end of a load into a cinch so that the cargo can be dragged. The cost of such a device may be too high for an ATV owner that only requires such a device for the occasional small job. In addition, many ATV owners already have winches mounted on the front of their vehicles, in which case it seems redundant to duplicate this part with a second winch on a towing structure.

### SUMMARY OF THE INVENTION

It is an object of the invention to provide a lift attachment for an ATV which includes a means of lifting cargo for carrying or dragging behind the ATV using an existing winch mounted on the front of the vehicle.

According to an aspect of the invention there is provided a lift attachment an ATV for mounting on an ATV comprising:

a bottom mounting bar shaped and arranged for connection to a hitch coupling of the ATV so as to extend rearwardly from the hitch to a rear end;

a support arm attached to the rear end of the bar and extending in an inclined direction upwardly and rearwardly therefrom;

the support arm including a first outer tubular portion and a second inner portion slidable within the outer portion such that a length of the arm is adjustable and can be set at selected lengths;

an inclined support portion connected to the top of the support arm and inclined thereto so as to extend rearwardly therefrom to an outer end;

a coupling plate at the outer end having a hole therein for receiving a hook of a support pulley block;

and a pulley located on a side of the support arm opposite the hitch at the bottom of the support arm such that a cable from a winch on the ATV can pass underneath the ATV to the pulley, around the pulley to the pulley block on the end of the support portion and to a load to be lifted and towed by the ATV.

Preferably the coupling plate is attached on an end of the support portion at right angles to the length thereof.

Preferably the support arm includes an outer bottom tube and an inner portion at the top slidable within the outer tube and wherein the support portion acts as a stop to limit downward movement of the inner portion into the outer tube.

Preferably there is provided an additional bracket for attachment to the ATV at a position thereon above the hitch and wherein the bracket includes a pair of rearwardly extending plates for receiving and locating the support arm between the plates at a point thereon above the hitch.

Preferably there is provided an additional bracket for attachment to the ATV at a front of the ATV below the winch with the additional bracket carrying a pulley thereon for guiding the cable from the winch underneath the ATV.

According to a second aspect of the invention there is provided an ATV combination including a lift attachment for mounting on the ATV comprising:

an ATV having a frame, front wheels, rear wheels, a hitch coupling on the frame between the rear wheels and a winch mounted on the frame at the front;

a front bracket for mounting on the frame at the front between the front wheels and having a pulley thereon for guiding the cable from the winch underneath the ATV to travel between the wheels to the rear;

a bottom mounting bar shaped and arranged for connection to the hitch coupling of the ATV so as to extend rearwardly from the hitch to a rear end;

a support arm attached to the rear end of the bar and extending in an inclined direction upwardly and rearwardly therefrom;

the support arm including a first outer tubular portion and a second inner portion slidable within the outer portion such that a length of the arm is adjustable and can be set at selected lengths;

an inclined support portion connected to the top of the support arm and inclined thereto so as to extend rearwardly therefrom to an outer end;

a coupling plate at the outer end having a hole therein for receiving a hook of a support pulley block;

and a pulley located on a side of the support arm opposite the hitch at the bottom of the support arm such that a cable from the winch on the ATV can pass underneath the ATV to the pulley, around the pulley to the pulley block on the end of the support portion and to a load to be lifted and towed by the ATV.

Preferably the coupling plate is attached on an end of the support portion at right angles to the length thereof.

Preferably the support arm includes an outer bottom tube and an inner portion at the top slidable within the outer tube and wherein the support portion acts as a stop to limit downward movement of the inner portion into the outer tube.

Preferably there is provided an additional bracket for attachment to the ATV at a position thereon above the hitch and wherein the bracket includes a pair of rearwardly extending plates for receiving and locating the support arm between the plates at a point thereon above the hitch.

### BRIEF DESCRIPTION OF THE DRAWINGS

One embodiment of the invention will now be described in conjunction with the accompanying drawings in which:

FIG. 1 is a side view embodiment of the present invention.

FIG. 2 is a side view embodiment of the present invention as intended to be attached to an ATV (represented without detail) having a winch already installed on the front of the vehicle.

### DETAILED DESCRIPTION

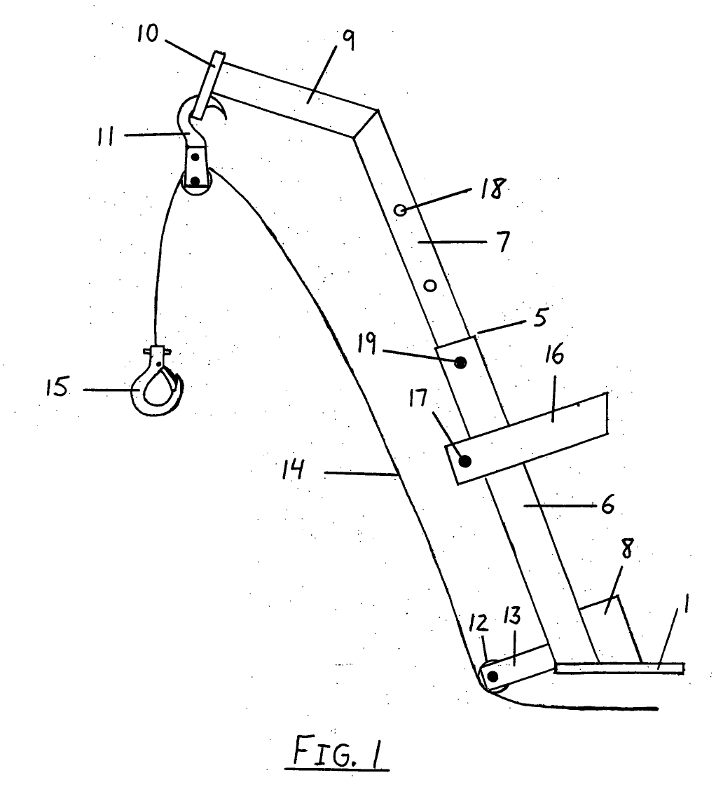

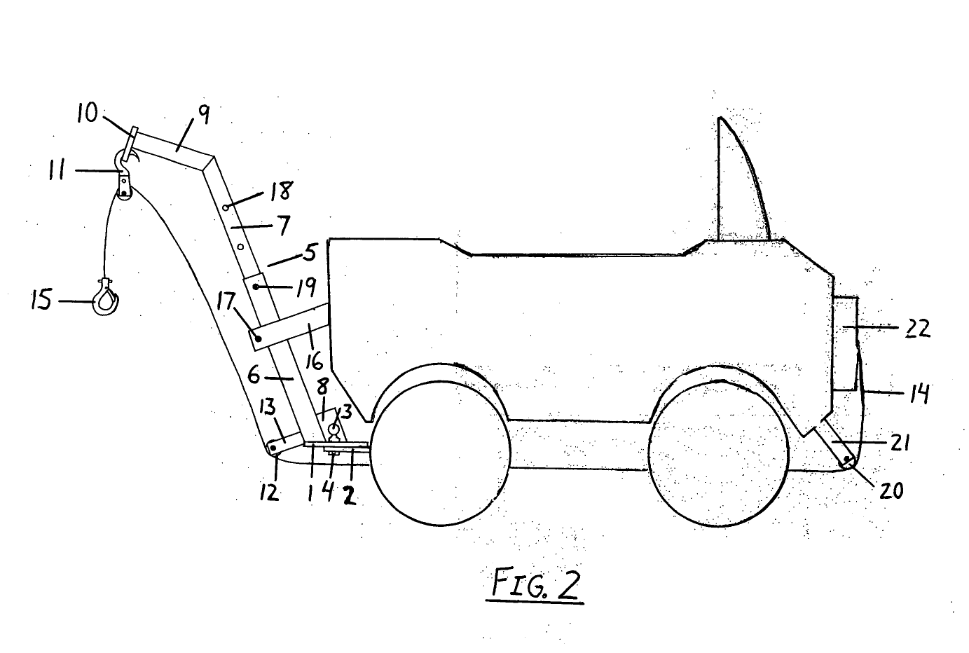

FIGS. 1 and 2 show a lift attachment for an ATV having a bottom mounting bar 1 that is rectangular in shape and is mounted on the top surface of the hitch coupling 2 of the ATV. This mounting bar 1 has a vertical hole through it that is aligned with the vertical hole through the hitch coupling 2 so that the ball hitch 3 can be placed atop the mounting bar 1 with the threaded portion passing downward through the mounting bar 1 and hitch coupling 2. When the ball hitch nut 4 is engaged on the threads below the hitch coupling 2 and tightened appropriately, the mounting bar 1 will be firmly held in place between the ball hitch 3 and the hitch coupling 2.

A support arm 5 is connected to the rearward end of the mounting bar 1 and extends upward and rearward from said bar. The support arm 5 consists of a stationary tubular outer portion 6 and a slidable inner portion 7. In order to reinforce the stability of the support arm 5 with respect to the mounting bar 1, a gusset 8 is connected to both the mounting bar 1 and the outer portion of the support arm 6 and is located beside the ball hitch 3.

Connected to the uppermost end of the slidable inner portion of the support arm 7 is an inclined support portion 9 that extends rearwardly and upwardly. A coupling plate 10 is connected to the rearward end of the inclined support portion 9. This coupling plate 10 has a hole therein allowing a support pulley block 11 to hang from it. A pulley is 12 rotatably mounted on a mounting bracket 13 that is connected to the side of the outer portion of the support arm 6 opposite the ball hitch 3. The cable 14 from the front of the ATV runs under the pulley 12 and then upwardly and rearwardly over the pulley of the support pulley block 11. The end of the cable is connected to a gated hook 15 or other device suitable for lifting the load being transported.

A bracket 16 composed of two plates extending rearwardly from the ATV adds to the stability to the lift device. These two plates are spaced horizontally apart by the width of the outer portion of the support arm 6 and are connected by a third plate that is bolted to the frame of the ATV. The rearward end of the bracket 16 locates and receives the outer portion of the support arm 6 preventing unwanted sway of the lift attachment under heavy loading. The two plates have holes therein to accept an anchor pin 17 that connects the plates at a point rearward of the outer portion of the support arm 6.

A hole near the upward end the outer portion of the support arm 6 is aligned with one of the holes 18 in the slidable inner portion of the support arm 7 in order to pass a support pin 19 through the entire support arm 5. When the support pin 19 is in place, it prevents movement of the slidable inner portion 7 relative to the outer portion 6 of the support arm. Removal of the support pin 19 allows the inner portion 7 to slide freely within the outer portion 6. The inclined support portion 9 prevents the slidable inner portion of the support arm 7 from sliding too far into the outer portion 6 by coming into contact with the upper end of said tubular outer portion 6.

Another pulley 20 is rotatably mounted on a mounting bracket 21 at the front of the ATV. The bracket 21 is attached to the ATV generally centrally below the winch assembly 22 already installed on the front of the vehicle. The cable 14 is run downward from the winch assembly 22, under the pulley 20 at the front of the vehicle, under the second pulley 12 at the rear of the vehicle, then rearwardly and upwardly over the pulley in the support pulley block 11 hanging from the coupling plate 10. The pulleys ensure an unobstructed path for the cable as it is pulled 14 between the winch assembly 22 at the front of the ATV and the support pulley block 11 at the rear end of the lift attachment.

Removal of the anchor pin 17, the ball hitch 3 and ball hitch nut 4 allows the bulk of the assembly to be removed from the ATV, leaving only the bracket 16 and front pulley 20 attached. These unobtrusive parts would be unlikely to interfere with normal operation of the ATV for recreational uses where the presence of the full lift attachment would be undesirable.

Due to design differences between various models of ATV's and trailer hitches, modification of the invention may be necessary to mount the lift attachment on a particular ATV. The changes necessary to do so would be obvious to one of ordinary skill in the art.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A lift attachment for mounting on an ATV comprising:
a bottom mounting bar shaped and arranged for connection to a hitch coupling of the ATV so as to extend rearwardly from the hitch to a rear end;
a support arm attached to the rear end of the bar and extending in an inclined direction upwardly and rearwardly therefrom;
the support arm including a first outer tubular portion and a second inner portion slidable within the outer portion such that a length of the arm is adjustable and can be set at selected lengths;
an inclined support portion connected to the top of the support arm and inclined thereto so as to extend rearwardly therefrom to an outer end;
a coupling plate at the outer end having a hole therein for receiving a hook of a support pulley block;
and a pulley located on a side of the support arm opposite the hitch at the bottom of the support arm such that a cable from a winch on the ATV can pass underneath the ATV to the pulley, around the pulley to the pulley block on the end of the support portion and to a load to be lifted and towed by the ATV.

2. The attachment according to claim 1 wherein the coupling plate is attached on an end of the support portion at right angles to the length thereof.

3. The attachment according to claim 1 wherein the support arm includes an outer bottom tube and an inner portion at the top slidable within the outer tube and wherein the support portion acts as a stop to limit downward movement of the inner portion into the outer tube.

4. The attachment according to claim 1 wherein there is provided an additional bracket for attachment to the ATV at a position thereon above the hitch and wherein the bracket includes a pair of rearwardly extending plates for receiving and locating the support arm between the plates at a point thereon above the hitch.

5. The attachment according to claim 1 wherein there is provided an additional bracket for attachment to the ATV at a front of the ATV below the winch with the additional bracket carrying a pulley thereon for guiding the cable from the winch underneath the ATV.

6. An ATV combination including a lift attachment for mounting on the ATV comprising:
an ATV having a frame, front wheels, rear wheels, a hitch coupling on the frame between the rear wheels and a winch mounted on the frame at the front;
a front bracket for mounting on the frame at the front between the front wheels and having a pulley thereon for guiding the cable from the winch underneath the ATV to travel between the wheels to the rear;
a bottom mounting bar shaped and arranged for connection to the hitch coupling of the ATV so as to extend rearwardly from the hitch to a rear end;
a support arm attached to the rear end of the bar and extending in an inclined direction upwardly and rearwardly therefrom;
the support arm including a first outer tubular portion and a second inner portion slidable within the outer portion such that a length of the arm is adjustable and can be set at selected lengths;
an inclined support portion connected to the top of the support arm and inclined thereto so as to extend rearwardly therefrom to an outer end;
a coupling plate at the outer end having a hole therein for receiving a hook of a support pulley block;
and a pulley located on a side of the support arm opposite the hitch at the bottom of the support arm such that a cable from the winch on the ATV can pass underneath the ATV to the pulley, around the pulley to the pulley block on the end of the support portion and to a load to be lifted and towed by the ATV.

7. The combination according to claim 6 wherein the coupling plate is attached on an end of the support portion at right angles to the length thereof.

8. The combination according to claim 6 wherein the support arm includes an outer bottom tube and an inner portion at the top slidable within the outer tube and wherein the support portion acts as a stop to limit downward movement of the inner portion into the outer tube.

9. The combination according to claim 6 wherein there is provided an additional bracket for attachment to the ATV at a position thereon above the hitch and wherein the bracket includes a pair of rearwardly extending plates for receiving and locating the support arm between the plates at a point thereon above the hitch.
